(19) United States
(12) Patent Application Publication
(10) Pub. No.: US 2016/0039082 A1
(43) Pub. Date: Feb. 11, 2016

(54) BARRIER MEMBER FOR A HANDHELD TOOL

(71) Applicant: MTD Products Inc, Valley City, OH (US)

(72) Inventors: Richard Winston Thomas, Scottsdale, AZ (US); Robert Bermudez, Gilbert, AZ (US); Mark Jankowski, Phoenix, AZ (US)

(21) Appl. No.: 14/453,205

(22) Filed: Aug. 6, 2014

(51) Int. Cl. B25F 5/02

(52) U.S. Cl. CPC B25F 5/02

(57) ABSTRACT

A portable handheld tool having a power head for powering a lawn maintenance implement is provided. The portable handheld tool may include a brush cutter, a blower, a vacuum, an edger, a polesaw, or the like. The power head includes an engine surrounded by a housing. The housing includes a transition surface having a heat dissipation and/or a heat isolating barrier member extending therefrom for allowing the user to rest their forearm against the barrier member during operation. The barrier member providing a contact surface having localized cooling generated by heat dissipating and/or heat isolation properties of the barrier member.

### FIELD OF THE INVENTION

The present invention is directed to portable handheld tools, and more particularly, to portable handheld tools used for lawn maintenance.

### BACKGROUND OF THE INVENTION

Portable tools such as string trimmers, brush cutters, blowers, vacuums, edgers, and the like are often used for lawn maintenance. These portable tools also often are powered by a gas-powered engine or motor, such as a 2-stroke or 4-stroke engine, that drives the working portion of the portable tool. Continuous usage of these tools over extended periods of time, such as an hour or more, tends to cause fatigue for the user.

These portable tools typically include a housing that surrounds the engine, a fuel port for adding fuel or an oil-fuel mixture, and a boom or other component that extends from the housing to drive an implement. The boom or other component is typically weighted so as to provide a balanced tool that does not cause unnecessary arm or back fatigue for the user. This fatigue can lead to the operator resting their forearm, elbow, or other part of their arm on the engine housing to help shift the weight and shock away from the wrist. However, the heat of the engine and the engine housing over extended and continued use during the day can injure the operator, even though the tool passes or exceeds standards for temperature of the components that can be contacted by a user during operation.

### BRIEF SUMMARY OF THE INVENTION

In one aspect of the present invention, a power head for a portable handheld tool having a housing surrounding an engine is provided. The power head includes a housing surrounding the engine. The housing includes a transition portion located between an upper portion and a forward portion. The housing further includes a barrier member attached to the transition portion, wherein the barrier member extends outwardly away from the transition portion for providing an area of contact for an operator.

In another aspect of the present invention, a power head for a portable handheld tool having a housing surrounding an engine is provided. The power head includes a housing surrounding the engine. The housing includes a top plate having a transition portion located between an upper portion and a forward portion. The power head further includes a barrier member attached to the transition portion, wherein the barrier member includes at least one heat dissipating property or at least one heat isolating property for providing a localized area of said housing having a reduced temperature.

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF SEVERAL VIEWS OF THE DRAWINGS

These and other features of the present invention, and their advantages, are illustrated specifically in embodiments of the invention now to be described, by way of example, with reference to the accompanying diagrammatic drawings, in which:

FIG. 1 is a perspective view of a portable handheld tool.

FIG. 2A is a perspective view of an embodiment of a power head of the portable handheld tool shown in FIG. 1.

FIG. 2B is a side view of the power head shown in FIG. 2A.

FIG. 2C is a top view of the power head shown in FIG. 2A.

FIG. 2D is an exploded view of the power head shown in FIG. 2A.

FIG. 3A is a perspective view of an embodiment of a barrier member.

FIG. 3B is a top view of the barrier member shown in FIG. 3A.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE PREFERRED EMBODIMENT

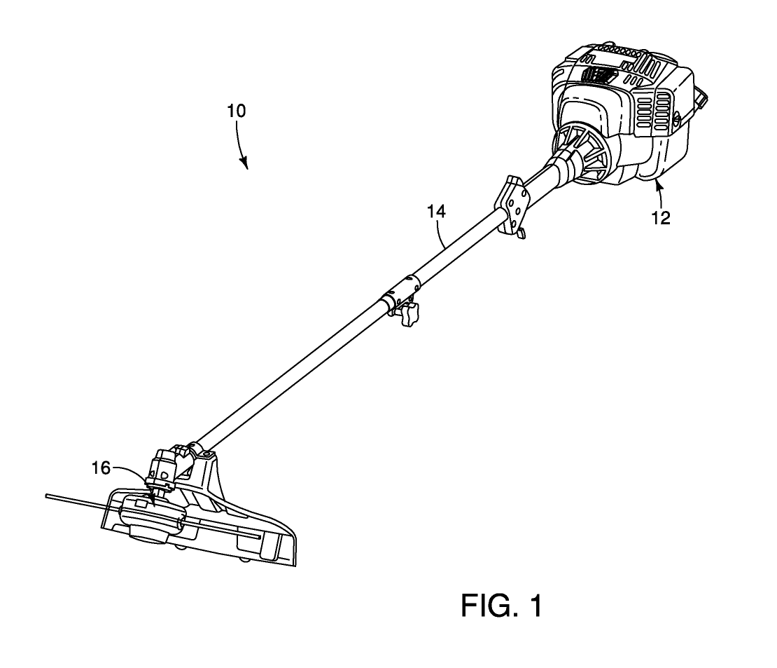

Referring to FIG. 1, an exemplary embodiment of a portable handheld tool 10 is shown. The illustrated tool 10 includes a power head 12 that is configured to be used to power a lawn maintenance implement attached to an elongated boom 14 extending from the power head 12. An implement 16, shown in FIG. 1 as a trimmer head, is attached to the end of the boom 14 opposite the power head 12. In an exemplary embodiment, the handheld tool 10 shown in FIG. 1 is a string trimmer. Other portable handheld tools 10 that can be powered by the power head 12 may include brush cutters, blowers, vacuums, edgers, polesaws, or the like, including any tool that is powered by a drive mechanism located within the power head 12. In these other types of handheld tools, the power head 12 is configured to generate the type of power to actuate each of these separate tools. For example, for a blower, the power head 12 is configured to provide rotational power to drive a fan (not shown) that generates the blowing force. In a similar manner, for a brush cutter, the power head 12 is configure to provide rotational power that is transferred through a boom 14 to a cutter head (not shown) that rotates at least one blade or wire for cutting brush.

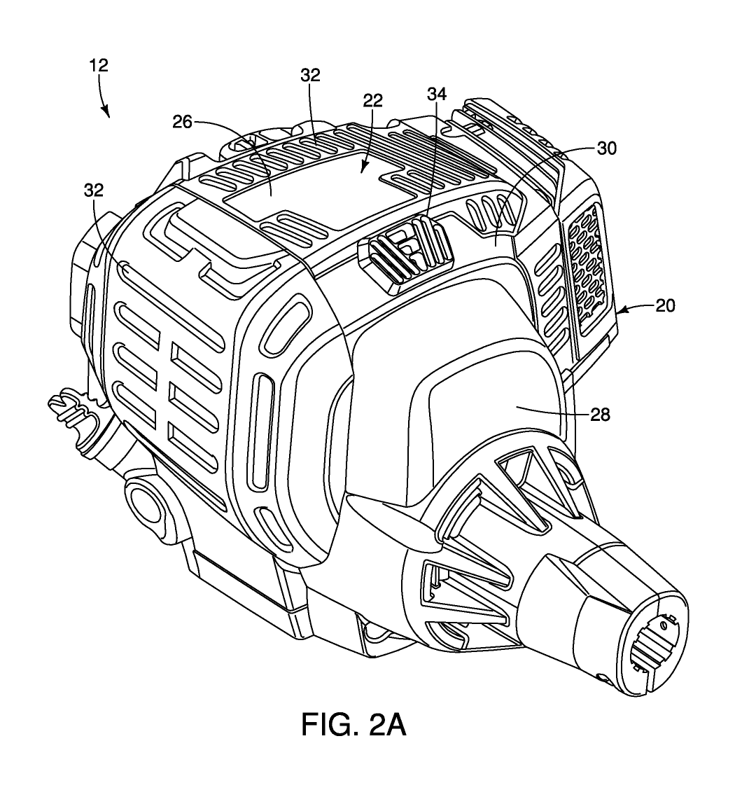

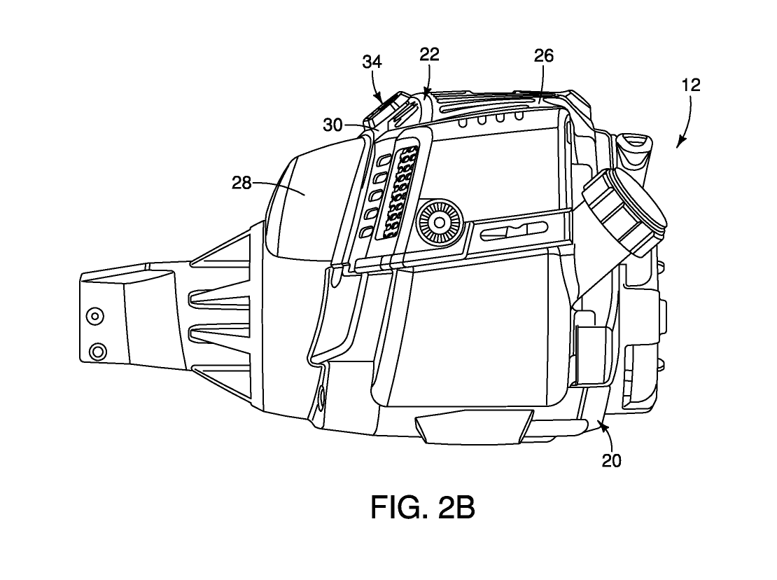

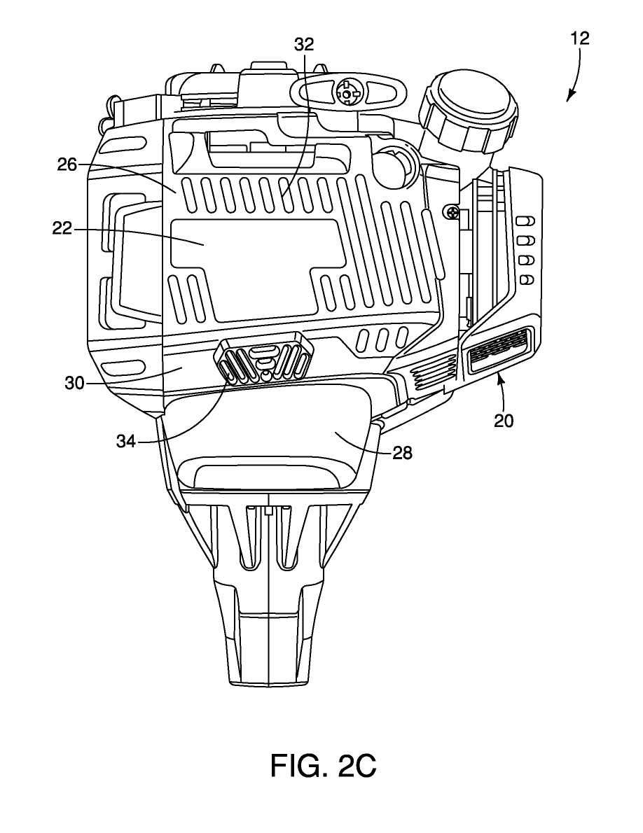

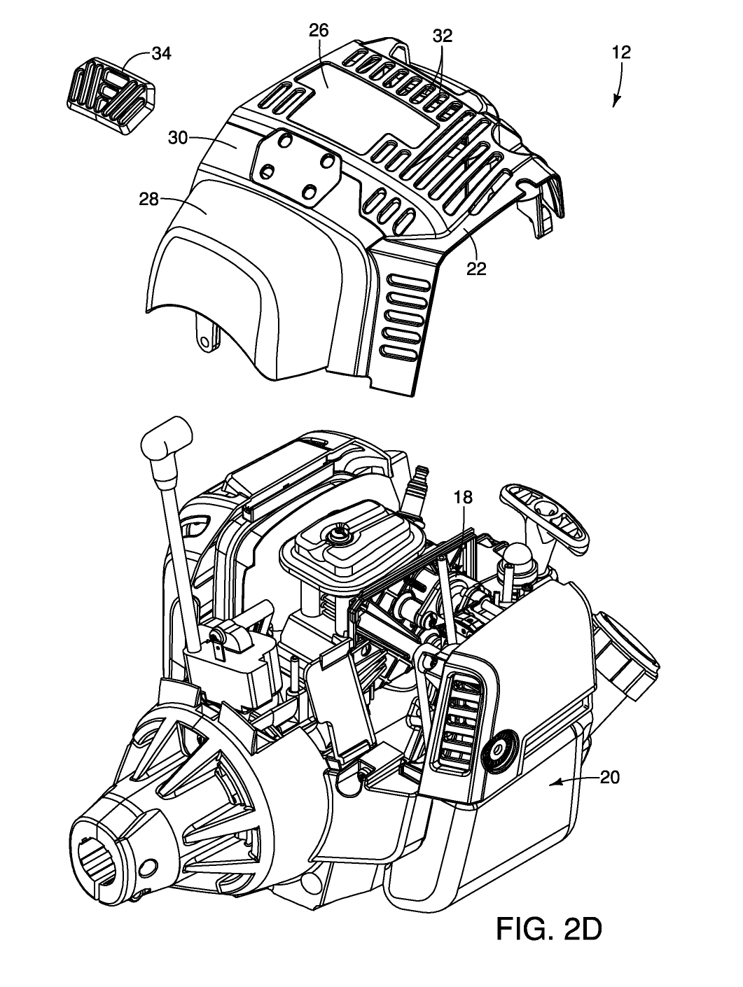

The power head 12 includes an internal combustion engine 18 configured to provide power to an implement attached to the boom 14, as shown in FIGS. 1 and 2A-2D. The engine 18 may be formed as a two-stroke, four-stroke, or other type sufficient to provide rotational driving power. In the illustrated embodiment of a string trimmer, the engine 18 generates rotational output for rotating the trimmer head 16. The engine 18 is located within a housing 20 that surrounds the engine 18 and provides protection thereto. The housing 20 is formed of multiple pieces.

The housing 20 includes a top plate 22 that is configured to be positioned adjacent to the engine 18, as shown in FIGS. 2A-2D. The top plate 22 is located above the engine 18 when the tool 10 is placed on the ground in a normal upright placement. In other words, when the tool 10 is done being used by the operator and the operator places the tool 10 on the ground, shelf, or otherwise stores the tool 10, the top plate 22 is the uppermost portion of the housing 20. As best seen in FIG. 2D, the top plate 22 includes an upper portion 26, a forward portion 28, and a transition portion 30. The upper portion 26 of the top plate 22 is oriented generally horizontal and is configured to be positioned over the top of the engine 18. The forward portion 28 is oriented generally vertical and is configured to be positioned over the front end of the power head 12, covering the connector to which the boom 14 is connected. The transition portion 30 extends between the upper portion 26 and the forward portion 28. In the illustrated embodiment, a portion of the top plate 22 extends rearwardly to cover a rear portion of the engine 18, but the rearwardly-extending portion of the top plate 22 provides a portion of material that allows the top plate to be secured to other portions of the housing 20. In other embodiments, the top plate 22 includes only the upper portion 26 and the transition portion 30.

When the tool 10 is being used by an operator, the transition portion 30 is typically positioned beneath the operator's forearm. During operation of the tool 10, particularly when used all day by professional landscapers or the like, the operator will sometimes adjust the tool 10 in order to rest their forearm, elbow, or other part of their arm against the transition portion 30. By doing this, the operator can transfer some of the shock of the tool—resulting from the engine running or the tool contacting plants or structures—from their wrist to their arm. Additionally, contacting the housing 20 with an operator's arm can also reduce fatigue that results from carrying the weight of the power head 12 for extended time periods. However, as described above, the transition portion 30 of the top plate 22 is positioned adjacent to the engine 18. The heat generated by the engine 18 can escape through the slots 32, or other venting apertures formed in the various pieces of the housing 20. Although these slots 32 help to dissipate the heat generated by the engine 18, the housing 20 itself absorbs some of the heat, which can make it uncomfortable for an operator that rests a forearm on the transition portion 30. While some tools 10 may include heat dissipating materials on the inside surfaces of the housing 20, which may include spray foams or the like, the housing 20 will still absorb and retain heat from the engine 18.

The transition portion 30, as shown in FIGS. 2A-2D, is a surface that is generally oriented substantially parallel to an operator's forearm when the tool 10 is in use. The transition portion 30 is an angled surface relative to the upper portion 26 and the forward portion 28, but it should be understood by one having ordinary skill in the art that the transition portion 30 may actually be a curved surface or other shape. It should also be understood by one having ordinary skill in the art that the upper and forward portions 26, 28 may also include slight curves or slopes that transition between those members and the transition portion 30. In other embodiments, the transition portion 30 may be a separate piece of the housing 20. The transition portion 30 is defined as the portion of the housing against which an operator can use to rest or otherwise contact with their forearm during operation.

A barrier member 34 is attached to the transition portion 30, as shown in FIGS. 2A-2D. The barrier member 34 is positioned on the transition portion 30 at a central location on the transition portion 30, wherein the central location is the most common location at which an operator's forearm, elbow, or other part of the arm would contact the transition portion 30. The central location on the transition portion 30 is generally the midpoint between the lateral edges of the transition portion 30 as well as the fore/aft midpoint thereof. In other embodiments, such as an edger, in which the operator's arm is located beneath the power head 12, the barrier member 34 is attached to a transition portion located on the bottom of the housing 20 at a location that the operator's arm would otherwise contact the housing 20. The barrier member 34 is formed with at least one heat dissipating property, at least one heat isolating property, or a combination thereof to provide an area on the housing 20 that provides an area of localized cooling or a localized area having a reduced temperature that allows an operator to contact this area with their arm for comfort during operation of the tool 10. These heat dissipating property may include heat dissipation structures used to produce the barrier member 34. The heat isolating properties of the barrier member 34 may include a particular shape or thermally isolating material properties.

The barrier member 34 is configured to provide the housing 20 with an area of localized cooling due to heat dissipation or heat isolation properties which results in an area of the housing 20 feeling cooler than other portions of the housing 20. This localized cooling of the barrier member 34 as a result of the increased heat dissipation provides for a cooler and a more comfortable contact area between the user and the tool 10, particularly in the area covered by the barrier member 34. The localized cooling also provides a better operator experience, particularly when the tool 10 is being used continuously for long time periods. The localized cooling of the barrier member 34 as a results of the heat isolating properties provides for a cooler and a more comfortable contact area. In some embodiments, the heat isolating properties of the barrier member 34 result from the barrier member 34 being formed of a softer material than the surrounding transition portion 30, thereby providing a more comfortable contact area. By allowing the operator to rest or otherwise contact the barrier member 34 on the transition surface 30, the operator can use the contact area to better control the tool 10 as well as transfer some of the shaking or movement of the tool 10 as well as the weight of the power head 12 from the wrist to the contact area of the operator's arm with the tool 10.

In an embodiment, the barrier member 34 is integrally formed with the transition portion 30 of the top plate 22. In another embodiment, the barrier member 34 is formed separate from the transition portion 30 and attached thereto. The barrier member 34 is configured to extend outwardly from the transition portion 30 of the housing 20, away from the engine 12. In an embodiment, the barrier member 34 is formed of the same material as the top plate 22. In another embodiment, the barrier member 34 is formed of a different material as the top plate 22. In other embodiments, the barrier member 34 is formed of multiple materials, one of which may or may not be the same material as the top plate 22.

As shown in FIGS. 2A-2D, the barrier member 34 protrudes outwardly away from the outer surface of the transition portion 30 of the top plate 22. This protrusion allows the contact area between the operator and the barrier member 34 to be spaced apart from the remainder of the housing 20 to prevent or reduce the likelihood of additional unintentional contact between the user and a higher temperature portion of the housing 20. In other embodiments, particularly embodiments of the tool 10 in which the operator's arm is below the power head 12 during operation, the barrier member 34 is positioned on a downwardly-directed surface of the housing 20.

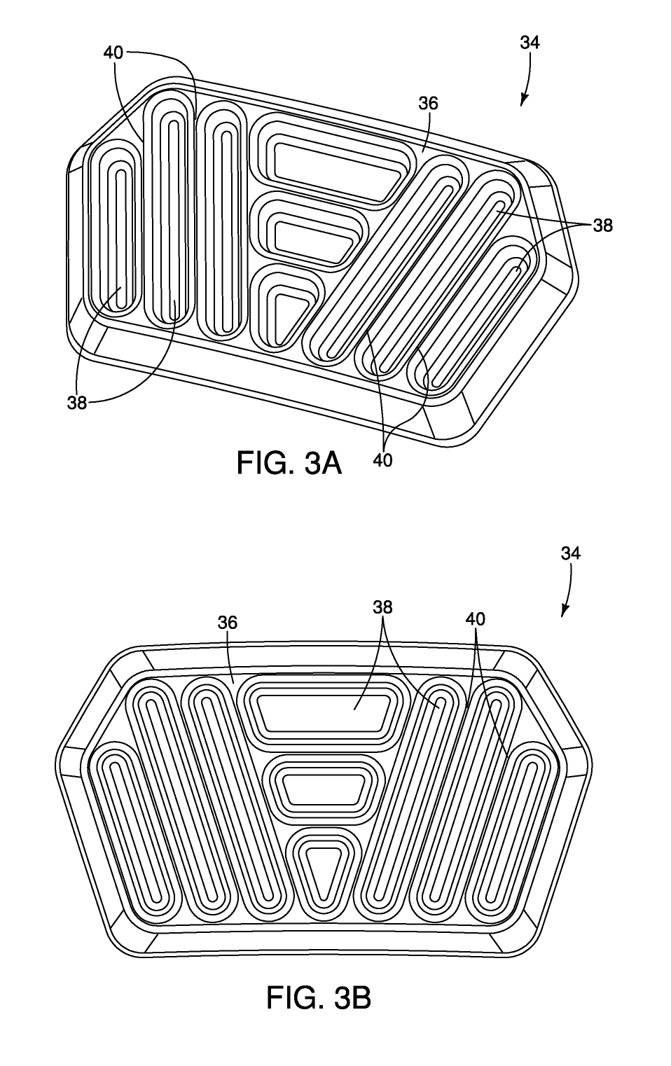

An exemplary embodiment of the barrier member 34 is shown in FIGS. 3A-3B. The barrier member 34 is formed as a generally polygonal-shaped member having a plurality of peripheral edges. The barrier member 34 has a lower surface and an upper surface 36, wherein the upper surface 36 is directed away from the housing 20 when secured to the transition portion 30. The upper surface 36 of the barrier member 34 includes a plurality of heat dissipating structures, which provides the heat dissipating property to the barrier member 34. In the exemplary embodiment shown in FIGS. 3A-3B, the heat dissipating structures are formed as recesses 38 that extend into the thickness of the barrier member 34 but do not extend through the entire thickness. The recesses 38 are formed into the upper surface 36 to increase the surface area of the barrier member 34, thereby increasing the heat dissipation from the barrier member 34 which results in added cooling of the barrier member 34. In addition, the recesses 38 into the upper surface 36 form ridges 40 between adjacent recesses 38. These ridges 40 reduce the potential surface area against which the operator can contact the tool 10. The recesses 38 of the illustrated embodiment form a triangular shape in the center of the barrier member 36 with three linear recesses 38 formed on each side of the triangular shape. It should be understood by one having ordinary skill in the art that any number of recesses 38 can be formed into the upper surface 36 of the barrier member 34. It should also be understood by one having ordinary skill in the art that the recesses 38 can be formed of any shape and arranged in any manner so as to provide increased surface area for added heat dissipation. In other embodiments, the heat dissipating structures formed on the upper surface 36 includes a plurality of projections that extend upwardly from the upper surface 36, thereby forming valleys between each of the adjacent projections. The projections and valleys form increased surface area of the barrier member 36 to increase heat dissipation as well as reduce the surface area of contact with an operator.

In another embodiment (not shown), the barrier member 34 may also be formed to include heat isolating properties. In particular, a heat isolating property for the barrier member 34 may include the barrier member 34 formed as a domed pad or otherwise raised surface that rises above the surrounding top plate 22 without any heat dissipating structures. The raised surface of the barrier member 34 relative to the top plate 22 allows for a thicker barrier member 34, thereby further isolating an operator's arm from the heated engine. Additionally, if the barrier member 34 is formed as a separate member and attached to the surrounding top plate 22, the contact (points) between the barrier member 34 and the top plate 22 can be minimized, thereby providing heat isolation to the barrier member 34 as there is less material contact between the barrier member 34 and the top plate 22 through which the heat can be transferred. Further, the heat isolation properties may also include the material used to form the heat barrier 34 in which the heat barrier 34 is formed of a material that has a decreased heat transfer properties than the surrounding material of the top plate 22. For example, a foam heat barrier 34 does not transfer heat as well as injection-molded plastic (top plate), wherein the hear barrier 34 includes heat isolating properties. In this embodiment, the barrier member 34 utilizes heat isolation properties to provide for a reduced temperature area against which an operator can contact with a portion of the operator's arm.

In an embodiment, the barrier member 34 is fixedly attached to the transition portion 30 of the top plate 22 using an adhesive. The adhesive used can include insulating properties that aid in limiting the heat transfer from the surrounding housing as well as the engine to the barrier member 34. In other embodiments, the barrier member 34 is removably attached to the transition portion 30. In other embodiments, the barrier member 34 is attached to the transition portion 30 using flexible tabs extend from either the barrier member 34 or the transition portion 30 that are received in corresponding slots formed in the opposing member. The barrier member 34 can also be attached to the transition portion 30 by other mechanical fastening means.

In an embodiment in which the barrier member 34 is integrally formed with the top plate 22, the barrier member 34 is formed of injection-molded plastic. The barrier member 34 may also be formed of blow-molded plastic or ceramic. In embodiments in which the barrier member 34 is formed separately from the housing 20, the barrier member 34 can be formed of rubber, foam, vinyl, molded plastics, or ceramics.

In other embodiments, the barrier member 34 is configured to provide a cushioned member against which an operator may rest their arm during use of the handheld tool 10. This can be particularly useful when a motor is located at the opposing end of the boom 14 and the motor is powered by a battery located within the housing 20, whereby the weight distribution is shifted to the end of the boom opposite the housing 20 (not shown). In these embodiments, the battery (power source) does not typically produce the same amount of heat necessary for the barrier member 34 to have heat isolation properties or heat dissipation properties, but instead, the barrier member 34 provides a cushioned support surface for an operator.

While preferred embodiments of the present invention have been described, it should be understood that the present invention is not so limited and modifications may be made without departing from the present invention. The scope of the present invention is defined by the appended claims, and all devices, processes, and methods that come within the meaning of the claims, either literally or by equivalence, are intended to be embraced therein.

What is claimed is:

1. A power head for a portable handheld tool having an engine for driving an implement, said power head comprising:
a housing surrounding said engine, said housing having a transition portion located between an upper portion and a forward portion;
a barrier member attached to said housing, wherein said barrier member extends outwardly away from said housing for providing a surface area for contact by an operator.

2. The power head of claim 1, wherein said barrier member is fixedly attached to said transition portion.

3. The power head of claim 1, wherein said barrier member is removably attached to said transition portion.

4. The power head of claim 1, wherein said barrier member includes a plurality of heat dissipating structures.

5. The power head of claim 4, wherein said heat dissipating structures include recesses formed into an upper surface and extend into a thickness of said barrier member.

6. The power head of claim 1, wherein said barrier member includes at least one heat dissipating property or at least one heat isolating property for providing localized cooling.

7. The power head of claim 6, wherein said at least one heat dissipating property is heat dissipating structures.

8. The power head of claim 6, wherein said at least one heat isolating property is a material used to form said barrier member.

9. A power head for a portable handheld tool having an engine for driving an implement, said power head comprising:
a housing surrounding said engine, said housing having a top plate that includes a transition portion located between an upper portion and a forward portion;
a barrier member attached to said housing, wherein said barrier member includes at least one heat dissipating property or at least one heat isolating property for providing a localized area of said housing having a reduced temperature.

10. The power head of claim 9, wherein said at least one heat dissipating property is heat dissipating structures.

11. The power head of claim 10, wherein said heat dissipating structures include a plurality of recesses formed into an upper surface of said barrier member to provide said barrier member with additional surface area.

12. The power head of claim 10, wherein said heat dissipating structures include a plurality of projections extending from an upper surface of said barrier member to provide said barrier member with additional surface area.

13. The power head of claim 9, wherein said at least one heat isolating property is a material used to form said barrier member.

14. The power head of claim 9, wherein said barrier member includes both said heat dissipating property and said heat isolating property.

15. The power head of claim 14, wherein said heat dissipating property includes heat dissipating structures and said heat isolating property includes a material used to form said barrier member.

16. The power head of claim 9, wherein said barrier member is integrally formed with said housing.

17. The power head of claim 9, wherein said barrier member is formed separately from said housing.
